(19) United States
(12) Patent Application Publication
(10) Pub. No.: US 2008/0288550 A1
(43) Pub. Date: Nov. 20, 2008

(54) System and method for bridging file systems between two different processors in mobile phone

(75) Inventors: Chun-Chiao Wang, Taipei City (TW); Hsien-Ming Tsai, Tainan County (TW)

Correspondence Address: REED SMITH LLP, Suite 1400, 3110 Fairview Park Drive, Falls Church, VA, 22042, US

(73) Assignee: Quanta Computer Inc.

(21) Appl. No.: 11/979,616

(22) Filed: Nov. 6, 2007

(30) Foreign Application Priority Data
May 18, 2007 (TW) 096117824

(51) Int. Cl. G06F 17/30

(52) U.S. Cl. 707/200; 707/E17.005

(57) ABSTRACT

A mobile phone can include an application processor and a baseband processor. The application processor has a first file system and the baseband processor has a second file system. The baseband processor is connected to a host interface unit of the application processor via a memory bus. The baseband processor can set registers and FIFO queues of the host interface unit and thereby control the application processor to achieve the goal of exchanging information. The invention provides a bridging file system for bridging the file systems in the two processors. Thus, the first file system of the application processor can access files in the second file system of the baseband processor.

### BACKGROUND OF THE INVENTION

1. Field of the Invention

This invention generally relates to a mobile communication device. More specifically, the invention is related to a method for bridging the file systems of two processors in a mobile communication device.

2. Description of the Prior Art

Because the function of mobile phones have become more and more complicated, single processor can no longer bear all requirements of a feature phone. Hence, a feature phone can include two processors to work together and respectively perform different functions. Typically, there are a baseband processor and an application processor. The baseband processor provides communication services, manages wireless communication protocols, and controls a radio frequency module to receive/transmit RF signals. In addition, the baseband processor is also responsible for man machine interfaces (MMI), such as address books, phone operations, short messages, etc. For storing relative applications and data, the baseband processor has its own file system. The application processor provides multimedia services, such as photographing, audio/video recording, and displaying multimedia files. For rapidly accessing multimedia data, the application processor can also have its own file system.

Although the two processors respectively have a file system, sometimes they may need to access data stored in the other file system. For instance, a photo, taken by the application processor and stored in the file system of the application processor, may be processed by the baseband processor and transmitted via multimedia messaging services. Furthermore, the baseband processor may download a coded image from the cellular network and store the image in its file system; the application processor may subsequently read, decode, and display the image on the monitor. It can be seen that the baseband processor needs the data in the file system of the application processor. Similarly, the application processor needs the data in the file system of the baseband processor.

Generally, the application processor provides application programming interface (API) commands for the baseband processor to directly access data stored in the file system of the application processor. However, the application processor cannot directly access data stored in the file system of the baseband processor. To solve the problem, the invention provides a method and a system for bridging the file systems of two processors in a mobile phone. For short, the system according to the invention is called a bridging file system (BFS). With this system, the application processor can directly access data stored in the file system of the baseband processor.

The patent U.S. Pat. No. 6,987,961 discloses a method of simulating a network between two processors with a shared memory. Through a network file system conforming to TCP/IP protocols, the two processors can share data with each other. However, the network protocols are complicated and increases the loading of processors and memories. Therefore, this method is not suitable for mobile phones having only limited resources. Besides, the patent U.S. Pat. No. 6,161,104 discloses a method for enabling a client application to access data at a server application. However, this method must be implemented in a physical network (e.g. internet) and accordingly unsuitable for mobile phones.

### SUMMARY OF THE INVENTION

The invention provides a method and a system for bridging the file systems of two processors in a mobile phone. For short, the system according to the invention is called a bridging file system (BFS). With the BFS, a first file system of the application processor can directly access data stored in a second file system of the baseband processor. Physically, the baseband processor is connected to a host interface unit (HIU) of the application processor through a memory bus. According to the invention, the baseband processor can control and communicate with the application processor by setting registers and first-in-first-out (FIFO) queues.

According to the invention, two software modules are added. One is a BFS client executed at the application processor, and the other is a BFS host executed at the baseband processor. When the first file system of the application processor requests to access a file stored in the second file system of the baseband processor, the first file system dispatches a command to request the BFS client. Then, through the HIU, the BFS client dispatches an open/read/write/close/seek BFS command to the BFS host. At the baseband processor, the BFS host receives the BFS commands from the BFS client through the HIU, requests the second file system to execute the BFS commands, and transmits an executed result back to the BFS client through the HIU.

Compared with prior arts, the invention only adds two software modules: the BFS client and the BFS host. The original programs and designs of the two processors do not need to be changed. Furthermore, the BFS client and the BFS host only require few operations and memories. High-speed access can be achieved by setting the HIU via the memory bus. In addition, data opened by the BFS client and the BFS host can be completely or partially buffered in a memory, so as to speed up the efficiency of BFS read/write operations.

The advantage and spirit of the invention may be understood by the following recitations together with the appended drawings.

### BRIEF DESCRIPTION OF THE APPENDED DRAWINGS

FIG. 1 shows the basic block diagram of a mobile phone according to the invention.

FIG. 2 shows the software modules in the application processor and the baseband processor according to the invention.

FIG. 3 illustrates control flowcharts corresponding to several BFS commands.

FIG. 4 illustrates an exemplary flowchart of transmitting BFS commands/results between HIU client driver and HIU host driver via the HIU.

FIG. 5(A) illustrates an example of the file mapping table.

FIG. 5(B) illustrates an embodiment of the buffer region corresponding to the file mapping table in FIG. 5(A).

FIG. 6 shows an example that the BFS client buffers data in a memory.

FIG. 7 illustrates an exemplary BFS flow for writing an image taken by the application processor into the file system of the baseband processor.

FIG. 8 illustrates another embodiment of the flow for the HIU client driver and HIU host driver to transmit BFS commands/results via the HIU.

FIG. 9 illustrates another embodiment for the BFS host to arrange buffer regions.

### DETAILED DESCRIPTION OF THE INVENTION

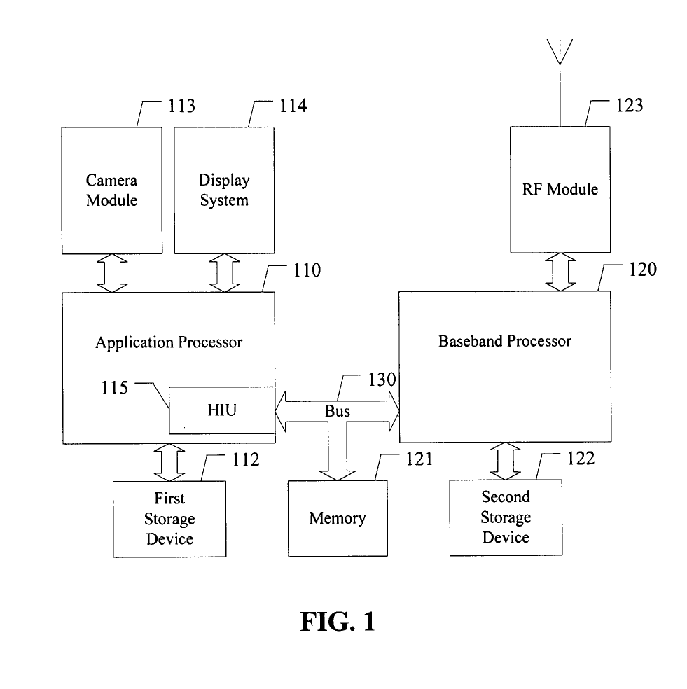

FIG. 1 shows the basic block diagram of a mobile phone according to the invention. This mobile phone mainly includes two sub-systems: a multimedia sub-system and a communication sub-system. The multimedia sub-system mainly includes an application processor 110, a camera module 113, a display system 114, a first storage device 112, and other peripherals. The application processor 110 is responsible for multimedia services, for example, controlling the camera module 113 to take photos/record video, controlling the display system 114 to display images, and accessing data in the storage device 112. The communication sub-system mainly includes a baseband processor 120, an RF module 123, a second storage device 122, a memory 121, and other peripherals. The baseband processor 120 is responsible for communication services and man machine interfaces(MMI). The baseband processor 120 mainly accesses data stored in the second storage device 122 and the memory 121. It should be noted that the baseband processor 120 is connected to the HIU 115 of the application processor 110 through a memory bus 130. The HIU 115 includes registers and FIFO queues. The baseband processor 120 can control and communicate with the application processor 110 by setting the registers and FIFO queues. The BFS according to the invention includes at least the application processor 110, the baseband processor 120, the second storage device 122, the memory 121, and the memory bus 130.

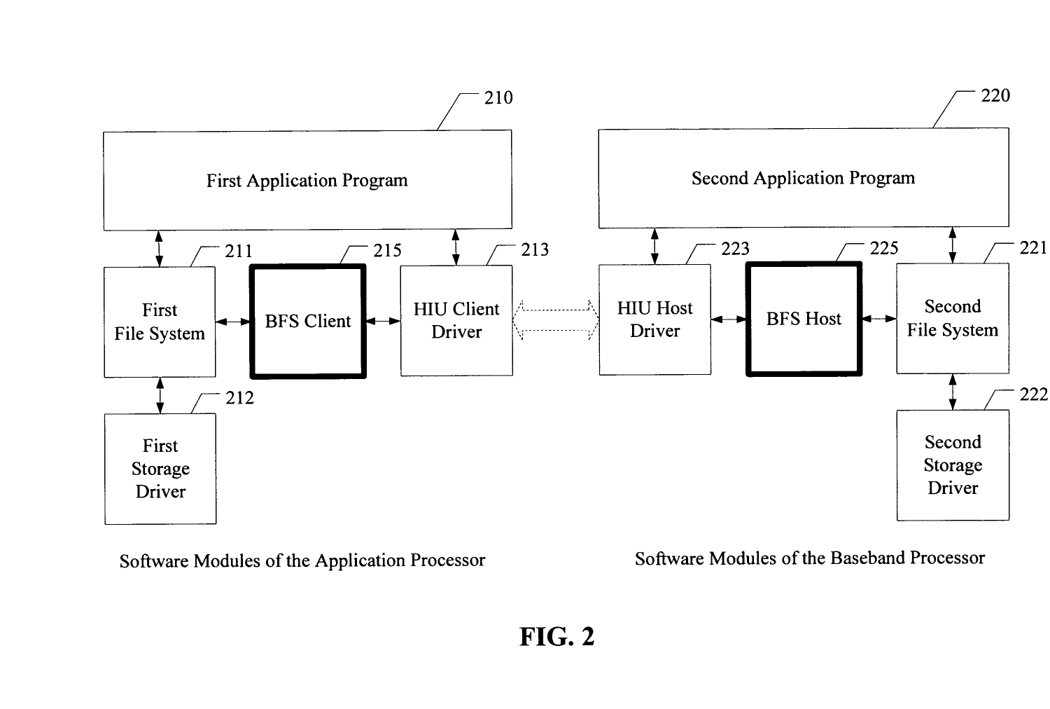

FIG. 2 shows the software modules in the application processor 110 and the baseband processor 120 according to the invention. The software modules of the application processor 110 mainly includes a first application program 210, an HIU client driver 213, a BFS client 215, a first file system 211, and a first storage driver 212. The software modules of the baseband processor 120 mainly includes a second application program 220, an HIU host driver 223, a BFS host 225, a second file system 221, and a second storage driver 222. The first application program 210 is responsible for multimedia functions. The first application program 210 can use the first file system 211, control the first storage driver 212, and access data in first the storage device 112. The second application program 220 is responsible for functions such as man machine interfaces. The second application program 220 can use the second file system 221, control the second storage driver 222, and access data stored in the second storage device 122. The baseband processor 120 is connected to the HIU 115 of the application processor 110 through the memory bus 130. The second application program 220 dispatches API commands to the HIU host driver 223. The HIU host driver 223 then transmits the commands to the HIU client driver 213 through the memory bus 130 and the HIU 115. Subsequently, the commands are further transmitted to the first application program 210 of the application processor 110. To enable the first file system 211 to access data stored in the second file system 221, the BFS client 215 is added into the application processor 110, and the BFS host 225 is added into the baseband processor 120. When the first application program 210 requests the first file system 211 to access a file, the first file system 211 first confirms whether the file is stored under the first file system 211 or the second file system 221. For example, if the path of the file begins with “A:\”, it implies the file is under the first file system 211; if the path of the file begins with “B:\”, it implies the file is under the second file system 221. Then, the first file system 211 will dispatch a command to the BFS client 215. The BFS client 215 will accordingly dispatch an open/read/write/close BFS command to the BFS host 225 through the HIU client driver 213. After receiving the BFS command, the BFS host 225 operates the second file system 221 to execute the open/read/write/close command and then transmits an executed result to the BFS client 215 through the HIU host driver 223.

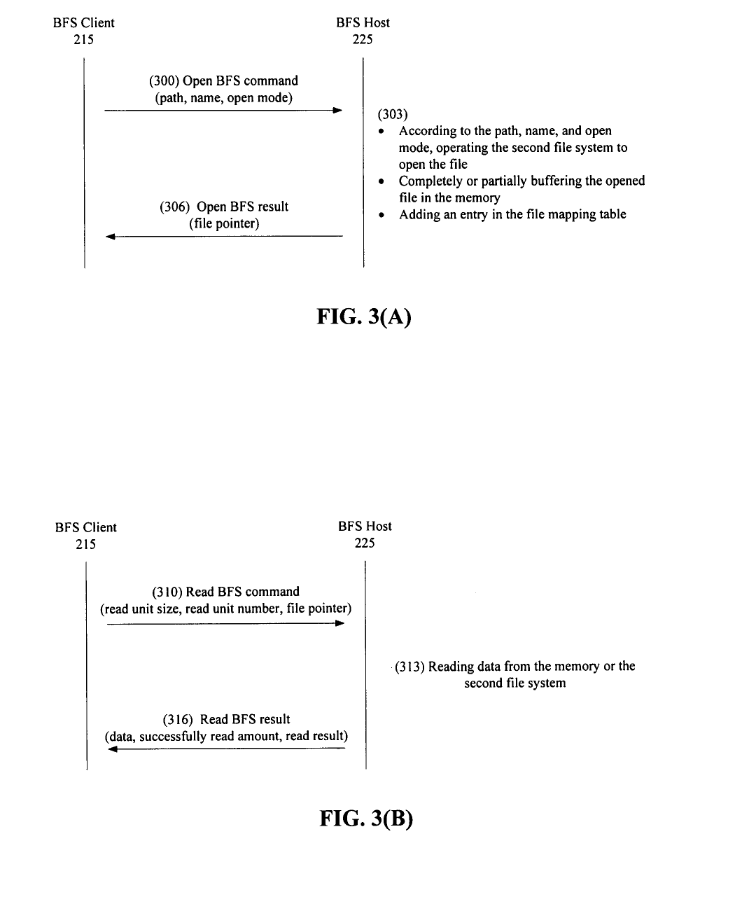

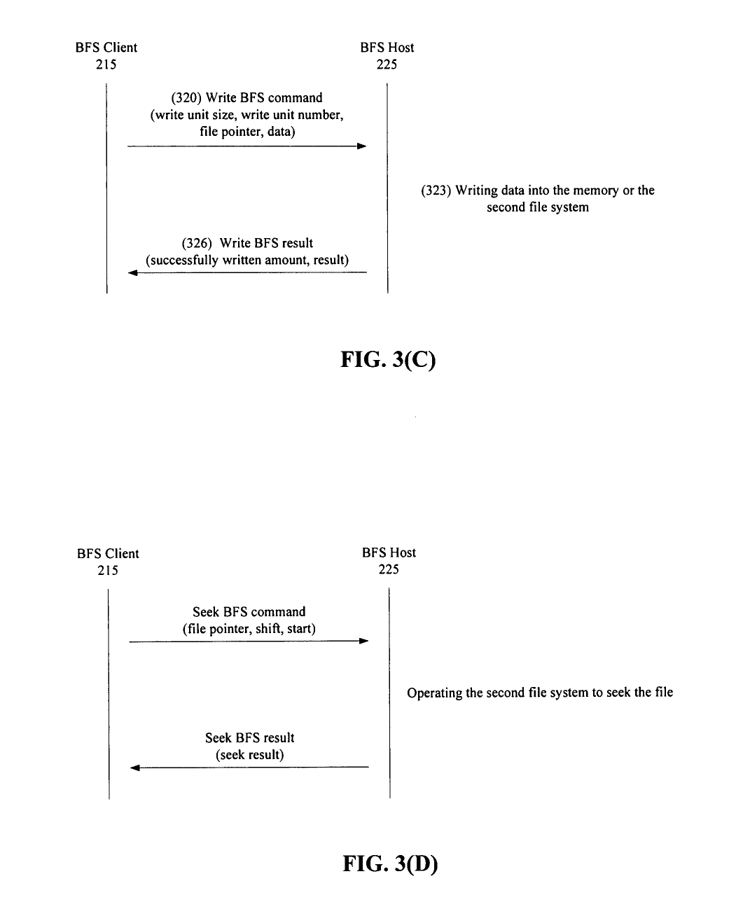

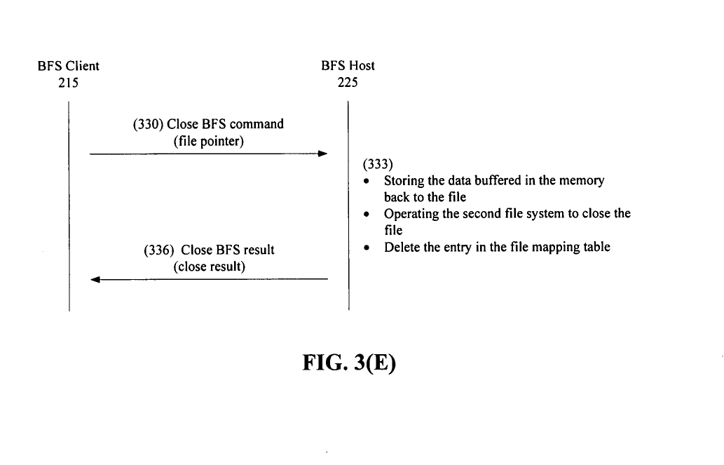

FIG. 3 illustrates control flowcharts corresponding to several BFS commands. FIG. 3(A) is the flowchart corresponding to an open BFS command. First, when the first application program 210 requests the first file system 211 to open a file, the first file system 211 confirms, according to the path of the file, whether the file is stored under the first file system 211 or the second file system 221. If the file is stored in the second file system 221, the first file system 211 transmits a command to the BFS client 215. In step 300, the BFS client 215 receives the command from the first file system 211 and then transmits an open BFS command to the BFS host 225. The open BFS command includes the path, name, and open mode of the file. In step 303, after receiving the open BFS command, the BFS host 225 of the baseband processor 120 operates the second file system 221 to open the file according to the path, name, and open mode. To speed up the efficiency of BFS read/write operations, the BFS host 225 according to the invention can completely or partially buffer the opened file in the memory 121. Accordingly, the BFS host 225 can add an entry in a file mapping table of the memory 121 to represent the file has been copied to the memory 121. In step 306, a result of opening the file is transmitted to the BFS client 215. For instance, if the file is successfully opened, a non-zero file pointer is transmitted back; if the file is not opened successfully, the file pointer is zero. After receiving the result, the BFS client 215 reports the result to the first application program 210 via the first file system 211.

FIG. 3(B) is the flowchart corresponding to a read BFS command. After a file is successfully opened, the first application program 210 can request to read the content of the file. Correspondingly, the first file system 211 will transmit a read command to the BFS client 215. In step 310, according to the read command, the BFS client 215 dispatch a read BFS command to the BFS host 225. The read BFS command can include a read unit size, a read unit number, and a file pointer corresponding to the file. In step 313, after receiving the read BFS command, the BFS host 225 operates the second file system 221 to read the file. To speed up the read efficiency, the opened file may be completely or partially buffered in the memory 121. Hence, the BFS host 225 can direct read the file in the memory 121 according to the file mapping table. In step 316, a result of reading the file is transmitted back to the BFS client 215. After receiving the result and read data, the BFS client 215 reports the result and data to the first application program 210 via the first file system 211.

FIG. 3(C) is the flowchart corresponding to a write BFS command. After a file is successfully opened, the first application program 210 can request to write data into the file. Correspondingly, the first file system 211 will transmit a write command to the BFS client 215. In step 320, according to the write command, the BFS client 215 dispatch a write BFS command to the BFS host 225. This command can include a write unit size, a write unit number, a file pointer, and data to be written. In step 323, after receiving the write BFS command, the BFS host 225 operates the second file system 221 to write data into the file. To speed up the write efficiency, the opened file may be completely or partially buffered in the memory 121. Hence, the BFS host 225 can direct write data into the file in the memory 121 according to the file mapping table. In step 326, a writing result is transmitted back to the BFS client 215. After receiving the result, the BFS client 215 reports the result to the first application program 210 via the first file system 211. Similarly, as shown in FIG. 3(D), the BFS according to the invention can also support a seek BFS command to change the read/write position.

FIG. 3(E) is the flowchart corresponding to a close BFS command. When the first application program 210 requests to close a file, a close command is transmitted to the BFS client 215. In step 330, the BFS client 215 dispatches a close BFS command to the BFS host 225. This command can include a file pointer relative to the file to be closed. In step 333, after receiving the close BFS command, the BFS host 225 can operates the second file system 221 to close the file according to the file pointer. If the file was completely or partially buffered in the memory 121, the second file system 221 needs to store the data buffered in the memory 121 back to the file and delete the entry corresponding to the file in the file mapping table. In step 336, a close result is transmitted back to the BFS client 215. After receiving the result, the BFS client 215 reports the result to the first application program 210 via the first file system 211.

FIG. 4 illustrates an exemplary flowchart of transmitting BFS commands/results between HIU client driver 213 and HIU host driver 223 via the HIU 115. First, in step 501, the HIU host driver 223 in the baseband processor 120 periodically inspects the register of the HIU 115 and waits for the command from the HIU client driver 213. After the BFS client 215 transmits a BFS command through the HIU client driver 213, in step 502, the HIU client driver 213 first sets the parameters of the BFS command in the register of the HIU 115. If the BFS command includes data, in step 503, the HIU client driver 213 sets the data in the FIFO queue of the HIU 115. After setting the register and FIFO queue, in step 504, the HIU client driver 213 sets the BFS command in the register of the HIU 115. Thereafter, in step 505, the HIU client driver 213 periodically inspects the register of the HIU 115 and waits for the corresponding result from the HIU host driver 223. In step 506, HIU host driver 223 detects the BFS command from the HIU client driver 213. In step 507, the HIU host driver 223 reads the register of the HIU 115 and obtains the parameters of the BFS command. If the BFS command includes data, in step 508, the HIU host driver 223 reads the FIFO queue of the HIU 115 to obtain the data. After completely obtaining all the information relative to the BFS command, the HIU host driver 223 operates the BFS host 225 to process the BFS command.

After finishing processing the BFS command, the BFS host 225 transmits back a BFS result through the HIU host driver 223. In step 512, the HIU host driver 223 first sets the parameters of the BFS result in the register of the HIU 115. If the BFS result includes data, in step 513, the HIU host driver 223 sets the data in the FIFO queue of the HIU 115. After setting the register and FIFO queue, in step 514, the HIU host driver 223 sets the BFS result in the register of the HIU 115. Thereafter, step 501 is re-performed at the HIU host driver 223 to periodically inspect the register of the HIU 115 and wait for new commands from the HIU client driver 213. In step 516, the HIU client driver 213 detects the BFS result from the HIU host driver 223. In step 517, the HIU client driver 213 reads the register of the HIU 115 to obtain the parameters of the BFS result. If the BFS result includes data, in step 518, the HIU client driver 213 reads the FIFO queue if the HIU 115 to obtain the data. After completely obtaining all the information relative to the BFS result, the HIU client driver 213 operates the BFS client 215 to process the BFS result.

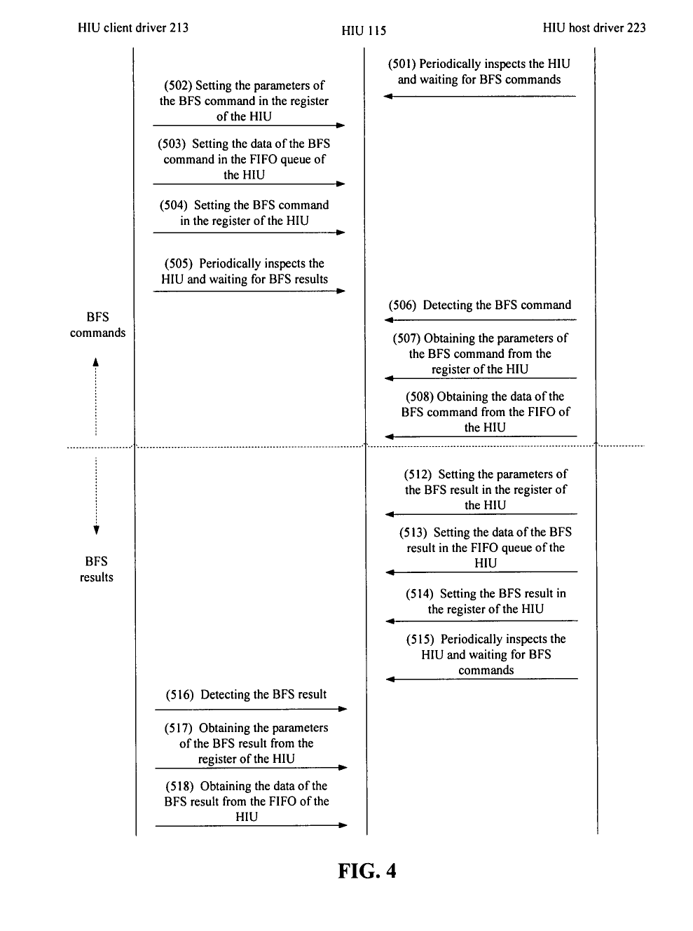

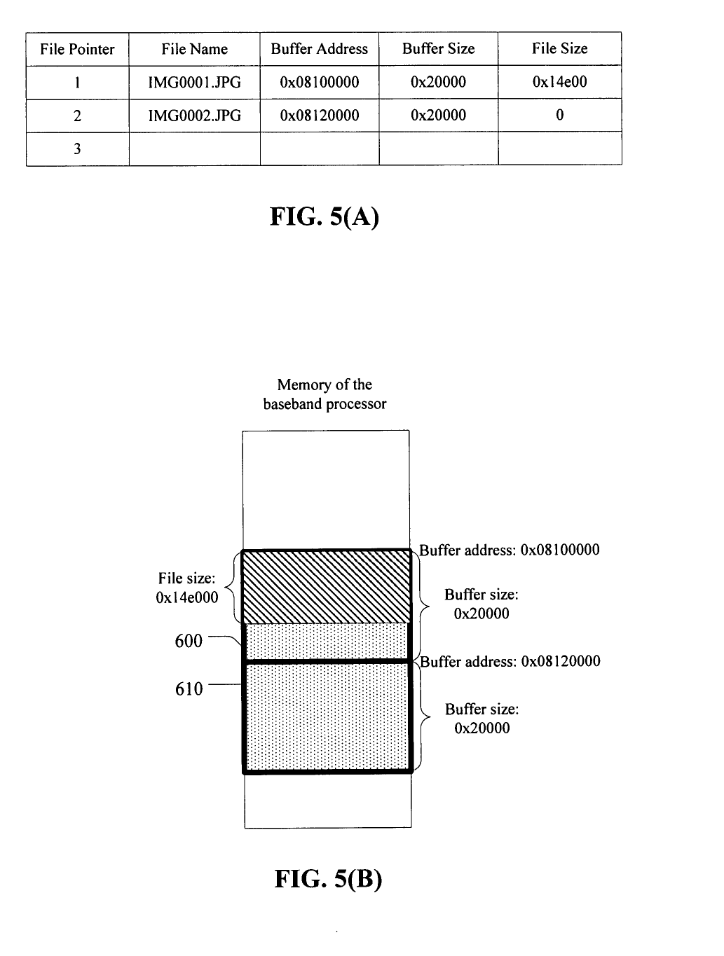

To increase the BFS performance, the BFS host 225 can completely or partially buffer opened file data in a memory and manage the memory with a file mapping table. FIG. 5(A) illustrates an example of the file mapping table. Every item of the file mapping table can include the columns of a file pointer, a file name, a buffer address, a file size, and a buffer size. After a file is opened by the BFS host 225, the name of the file is recorded in the name column, the size of the file is recorded in the file size column, and the data of the file is stored into a buffer region of the memory. The start address of the buffer region is recorded in the buffer address column; the size of the buffer region is recorded in the buffer size column. In this example, in the buffer region with the file pointer equal to one, a file named “IMG0001.JPG” is buffered. The size of the file is 0x14e00, the start address of the buffer region is 0x08100000, and the size of the buffer region is 0x20000. FIG. 5(B) illustrates an embodiment of the buffer region corresponding to the file mapping table in FIG. 5(A). In the memory 121, two buffer regions are assigned to BFS files. The buffer region 600 is assigned to the BFS file named IMG0001.JPG. Although the size of the buffer region 600 is 0x20000, the size of the file therein is 0x14e00. The buffer region 610 is assigned to the BFS file named IMG0002.JPG. Although the size of the buffer region 610 is 0x20000, the size of the file is 0; it implies no data is stored therein.

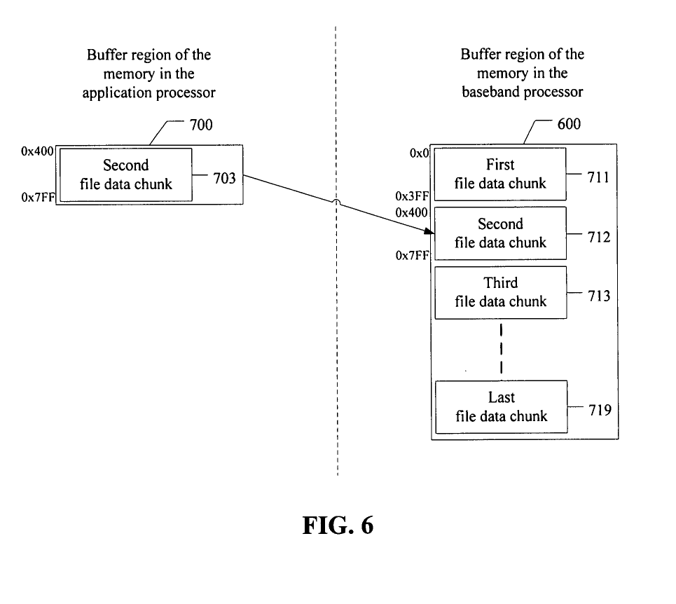

To further increase the read/write performance of BFS operations, the BFS client 215 can utilize the memory of the application processor 110 as a cache to buffer part of the file data. Thus, BFS client 215 does not need to access data through the HIU 115 every time. FIG. 6 shows an example that the BFS client 215 buffers data in a memory. The right side of FIG. 6 illustrates the buffer region 600 of the memory in the baseband processor 120; this region is used for buffer all the file data opened by the BFS host 225. In the buffer region 600, the data can be viewed as a combination of plural file data chunks (711˜719) with a fixed size (e.g. 1024 bytes). In this example, the first file data chunk 711 represents data with file shift from 0 to 0x3FF; the second file data chunk 712 represents data with file shifting from 0x400 to 0x7FF. The left side of FIG. 6 illustrates a file data chunk 703 of a buffer region 700 for the BFS client 215 in the application processor 110. The data in the file data chunk 703 is mapped from the second file data chunk 712. Accordingly, the BFS client 215 can directly utilize the data in the file data chunk 703 instead of the second file data chunk 712. If the data to be accessed by the BFS client 215 is not buffered in the file data chunk 703 (i.e. between the file shifting from 0x400 to 0x7FF), the BFS client 215 has to maintain the cache mechanism of this buffer region. First, it is checked whether the data in this buffer region was modified. If the data was modified, the file data chunk 703 is written back to the second file data chunk 712, and the needed data chunk is read to the buffer region 700 of the application processor 110.

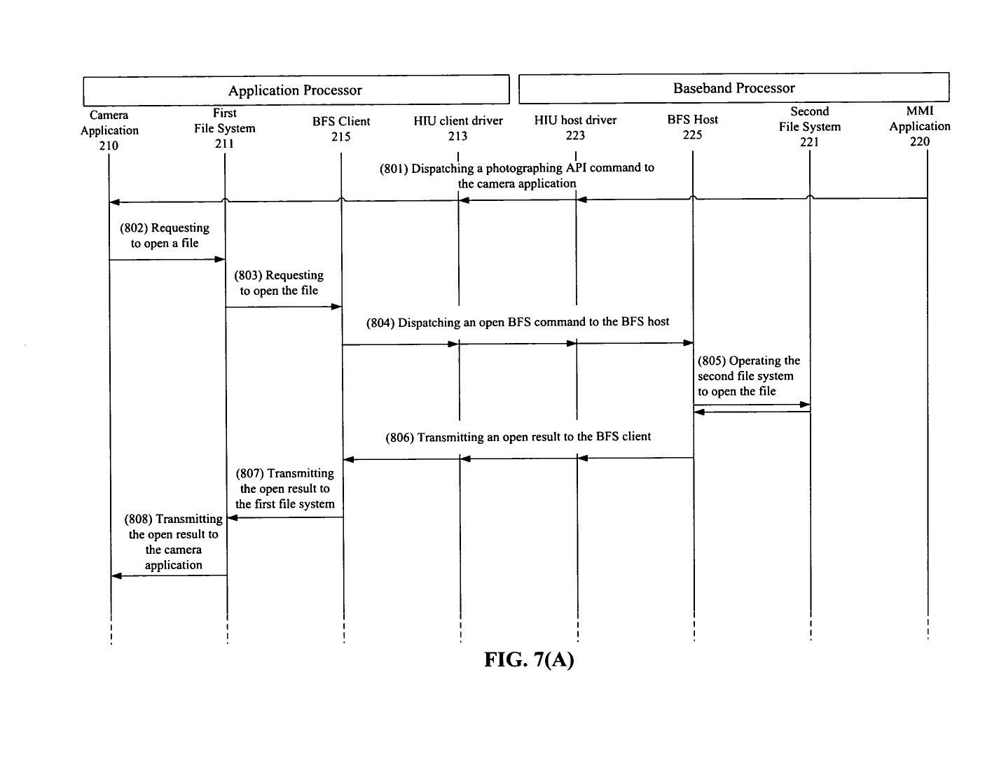

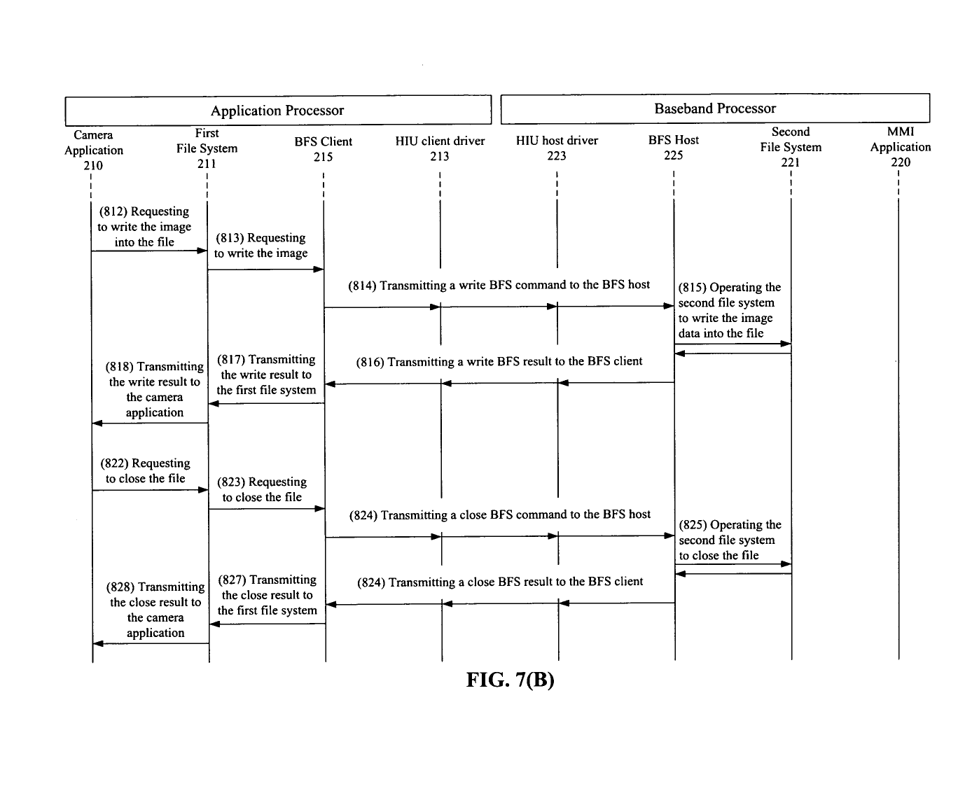

FIG. 7 illustrates an exemplary BFS flow for writing an image taken by the application processor 110 into the file system of the baseband processor 120. In this example, the man machine interface application 220 of the baseband processor 120 controls, with API commands, a camera application 210 of the application processor 110 to take an image and write the image into the file system of the baseband processor 120. As shown in FIG. 7(A), in step 801, the man machine interface application 220 dispatches a photographing API command to the camera application 210 through the HIU client driver 213 and the HIU host driver 223. In the photographing API command, the man machine interface application 220 requests the image should be written into the second file system 221 of the baseband processor 120. For instance, a path parameter of the photographing API command may be “B: \image”. In step 802, the camera application 210 requests the first file system 211 of the application processor 110 to open a file to store the image. According to the path parameter above, the first file system 211 confirms that the image is going to be stored in the second file system 221. In step 803, the BFS client 215 is requested to open the file. In step 804, based on the request from the first file system 211, the BFS client 215 dispatches an open BFS command to the BFS host 225 through the HIU client driver 213 and HIU host driver 223. The BFS command includes the name, path, and open mode of the file. For instance, the open mode “w” represents writing data into the file. In step 805, after receiving the open BFS command, the BFS host 225 operates the second file system 221 to open the file according to the name, path, and open mode in the BFS command. To speed up the efficiency of BFS operations, the BFS host 225 can completely or partially buffer the opened file in the memory 121. Correspondingly, an entry is added the file mapping table of the memory 121. In step 806, the BFS host 225 transmits an open result to the BFS client 215 through the HIU client driver 213 and HIU host driver 223. The result includes a file pointer. After receiving the result, the BFS client 215 transmits this result to the first file system 211 in step 807. In step 808, the first file system 211 transmits this result to the camera application 210.

FIG. 7(B) is the continuation of FIG. 7(A). After the file is successfully opened, in step 812, the camera application 210 can request the first file system 211 to write the image data into the file. In step 813, the first file system 211 requests the BFS client 215 to write data. In step 814, according to the request from the first file system 211, the BFS client 215 transmits a write BFS command to the BFS host 225 through the HIU client driver 213 and HIU host driver 223. The parameters of the write BFS command includes a write unit size, a write unit number, a file pointer corresponding to the file, and the image data to be written. In step 815, after receiving the write BFS command, the BFS host 225 operates the second file system 221 to write the image data into the file. To speed up the efficiency of BFS write operation, the BFS host 225 can write the image data into the buffer region of the memory 121 according to the file mapping table. In step 816, the BFS host 225 transmits a write result to the BFS client 215 through the HIU client driver 213 and HIU host driver 223. The write result includes the amount of successfully written data and an error message. After receiving the result, in step 817, the BFS client 215 returns this result to the first file system 211. In step 818, the first file system 211 transmits the result to the camera application 210. It should be noted that the data corresponding to an image can be divided into several parts written into a file separately. Therefore, steps 812 through 818 can be repeatedly performed until the data corresponding to the image is completely written. Thereafter, in step 822, the camera application 210 requests the first file system 211 to close the file. In step 823, the first file system 211 requests the BFS client 215 to close the file. In step 824, the BFS client 215 dispatches a close BFS command to the BFS host 225 through the HIU client driver 213 and HIU host driver 223. The parameter of the close BFS command includes the file pointer corresponding to the file. In step 825, after receiving the close BFS command, the BFS host operates the second file system 221 to close the file according to close BFS command. If the file was completely or partially buffered in the memory 121, the data buffered in the memory 121 is stored back to the file according to the file mapping table. The entry corresponding to the file in the file mapping table is then deleted. In step 826, a close result is transmitted back to the BFS client 215 through the HIU client driver 213 and HIU host driver 223. After receiving the result, the BFS client 215 reports the result to the first file system 211 in step 827. In step 828, the first file system 211 transmits the result to the camera application 210. Thereby, the image taken by the application processor 110 is stored into the second file system 221 of the baseband processor 120.

### Other Exemplary Embodiments

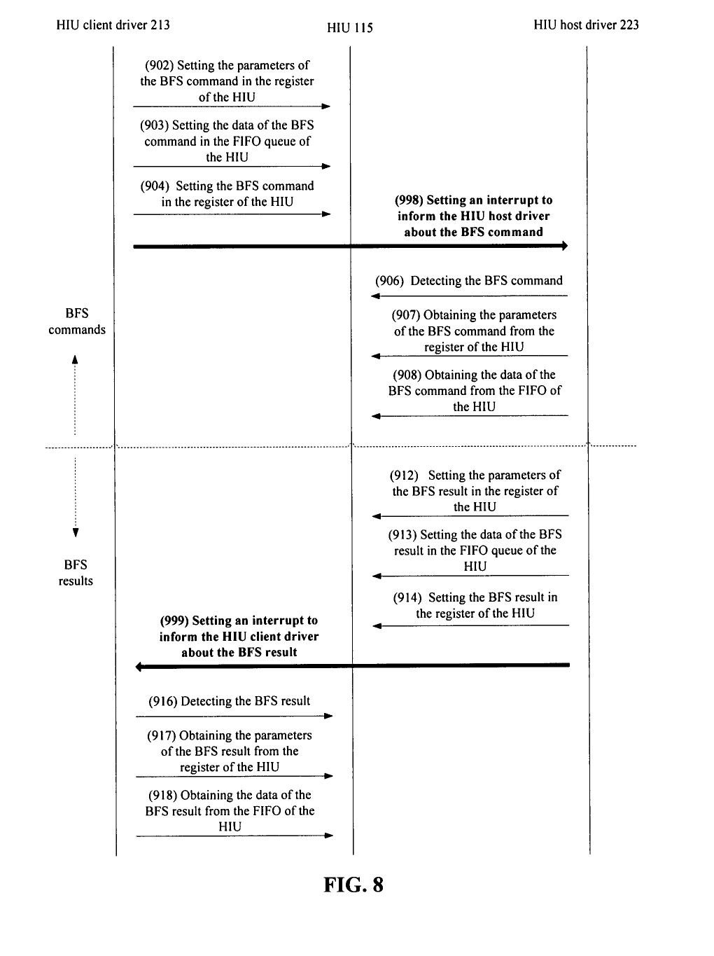

FIG. 8 illustrates another embodiment of the flow for the HIU client driver 213 and HIU host driver 223 to transmit BFS commands/results via the HIU 115. This embodiment is an improvement of that in FIG. 4 and has higher efficiency. In the embodiment of FIG. 4, the HIU client driver 213 and HIU host driver 223 continually check the existence of BFS commands/results by periodical polling. In the embodiment of FIG. 8, the HIU client driver 213 and HIU host driver 223 inform each other the existence of BFS commands/results by interrupts. Hence, the processors do not need to periodically check the HIU 115 and can execute other tasks more efficiently. Only until an interrupt is received, the processors check the BFS commands/results. The flowchart in FIG. 8 is similar to that in FIG. 4. The main difference is in steps 998 and 999. In step 998, the HIU client driver 213 sets an interrupt to inform the HIU host driver 223 about the existence of a BFS command. The function of step 501 is replaced by step 998. In step 999, the HIU host driver 223 sets an interrupt to inform the HIU client driver 213 about the existence of a BFS result. The function of step 505 is replaced by step 999. Higher efficiency is achieved.

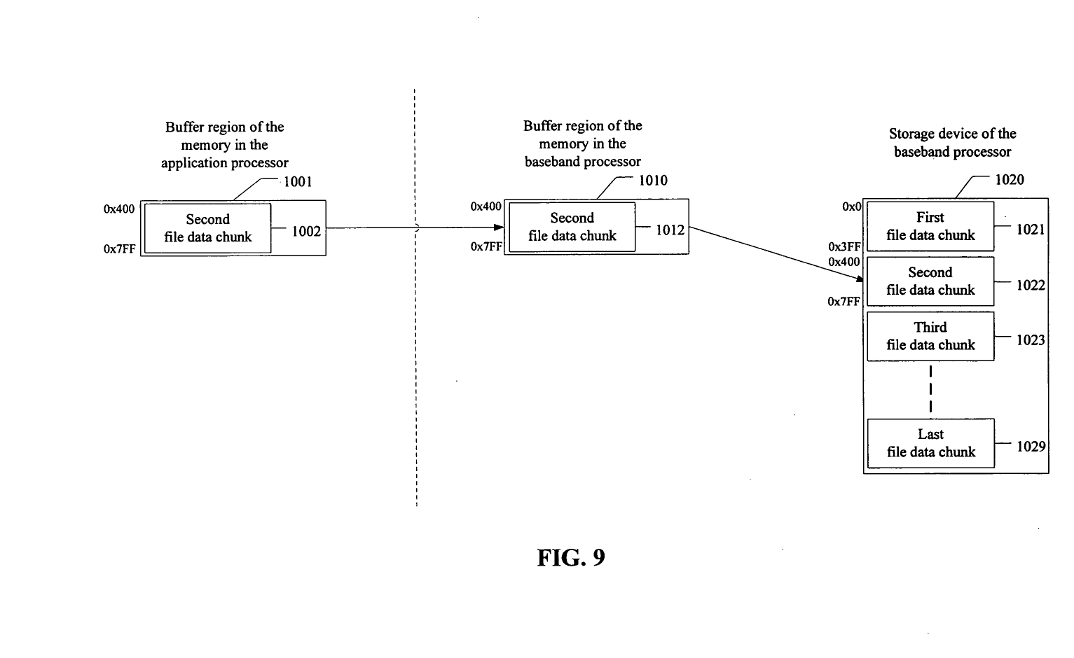

FIG. 9 illustrates another embodiment for the BFS host to arrange buffer regions. This embodiment is an improvement of that in FIG. 6. In this embodiment, the BFS host 225 only stores a part of an opened file in the buffer region instead of the whole file. Therefore, compared with the embodiment shown in FIG. 6, this embodiment utilizes smaller buffer spaces. The right part of FIG. 9 illustrates the complete file 1020 stored in the second storage device 122 of the baseband processor 120. The file 1020 can be viewed as a combination of plural file data chunks (1021˜1029) with a fixed size. The middle part of FIG. 9 illustrates a file data chunk 1012 mapped from the file data chunk 1022. The file data chunk 1012 is stored in the buffer region 1010 of the baseband processor 120. The left part of FIG. 9 illustrates a buffer region 1001 of the application processor 110. According to the embodiment of FIG. 6, the BFS client 215 stores a file data chunk 1002 mapped from the file data chunk 1012 in the buffer region 1001. When wanting to access the file data chunk 1022, the BFS client 215 can directly access the file data chunk 1002 in the buffer region 1001. If the data to be accessed by the BFS client 215 is not buffered in the file data chunk 1022, the BFS client 215 has to maintain the cache mechanism of this buffer region. First, it is checked whether the data in this buffer region was changed. If the data was changed, the file data chunk 1002 is written back to the file data chunk 1012 in the baseband processor 120, and the second file system 221 is operated to write the file data chunk 1012 back to the file in the second storage device 122.

The invention provides a method and a system for bridging the file systems of two processors in a mobile phone. With the BFS according to the invention, the first file system of the application processor can directly access data stored in the second file system of the baseband processor through the HIU. According to the invention, two software modules are added. One is a BFS client executed at the application processor, and the other is a BFS host executed at the baseband processor. The BFS host receives and responses to the BFS command from the BFS client through the HIU. Compared with prior arts, in the invention, the original programs and designs of the two processors do not need to be changed. Furthermore, the BFS client and the BFS host only require few operations and memories. High-speed access can be achieved by setting the HIU via the memory bus. In addition, data opened by the BFS client and the BFS host can be completely or partially buffered in a memory, so as to speed up the efficiency of BFS read/write operations.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A method for bridging a first file system and a second file system in a mobile communication device, the mobile communication device comprising an application processor and a baseband processor, the application processor comprising an interface unit, the first file system, and a bridging file system (BFS) client module, the baseband processor comprising the second file system and a BFS host module, the method comprising the steps of:
(a) in response to a request of the first file system, transmitting a BFS command from the BFS client module to the BFS host module via the interface unit;
(b) at the BFS host module, requesting the second file system to perform a file processing procedure according to the BFS command; and
(c) via the interface unit, transmitting a BFS result from the BFS host module to the BFS client module.

2. The method of claim 1, wherein step (a) comprises:
(a1) temporarily storing a target parameter corresponding to the BFS command into a register of the interface unit;
(a2) temporarily storing target data corresponding to the BFS command into a first-in-first-out (FIFO) queue of the interface unit;
(a3) temporarily storing the BFS command into the register of the interface unit;
(a4) transmitting an interrupt request from the interface unit to the BFS host module;
(a5) after the BFS host module receives the interrupt request, transmitting the BFS command and the target parameter from the register to the BFS host module; and
(a6) transmitting the target data from the FIFO queue to the BFS host module.

3. The method of claim 1, wherein the BFS host module and the BFS client module periodically inspect the interface unit to detect whether the BFS command is temporarily stored in the interface unit.

4. The method of claim 1, wherein step (c) comprises:
(c1) temporarily storing a result parameter corresponding to the BFS result into a register of the interface unit;
(c2) temporarily storing result data corresponding to the BFS result into a FIFO queue of the interface unit;
(c3) temporarily storing the BFS result into the register of the interface unit;
(c4) transmitting an interrupt request from the interface unit to the BFS client module;
(c5) after the BFS client module receives the interrupt request, transmitting the BFS result and the result parameter from the register to the BFS client module; and
(c6) transmitting the result data from the FIFO queue to the BFS client module.

5. The method of claim 1, wherein the BFS command represents the first file system requests the second file system to open a target file, the BFS command comprises an open mode, a target file path, and a target file name of the target file, and the BFS result comprises a file pointer.

6. The method of claim 1, wherein the BFS command represents the first file system requests the second file system to read a target file, the BFS command comprises a read unit size, a read unit number, and a file pointer, and the BFS result comprises read data, a successfully-read number, and a read result.

7. The method of claim 1, wherein the BFS command represents the first file system requests the second file system to write data into a target file, the BFS command comprises a write unit size, a write unit number, and a file pointer, and the BFS result comprises a successfully-written number, and a write result.

8. The method of claim 1, wherein the BFS command represents the first file system requests the second file system to search a target file, the BFS command comprises a file pointer, a shift amount, and a start point, and the BFS result comprises a search result.

9. The method of claim 1, wherein the mobile communication device further comprises a memory, if the BFS command represents the first file system requests the second file system to open a target file, in the file processing procedure, the second file system temporarily stores the target file in the memory, and adds an entry corresponding to the target file in a file mapping table of the memory.

10. The method of claim 9, wherein the application processor further comprises a second buffer memory, after step (c), the BFS client module temporarily stores the BFS result into the second buffer memory.

11. A mobile communication device, comprising:
an application processor, comprising:
an interface unit;
a first file system; and
a bridging file system (BFS) client module, when the first file system transmits a request to the BFS client module, the BFS client module transmitting a BFS command via the interface unit; and
a baseband processor, comprising:
a second file system; and
a BFS host module, after receiving the BFS command from the interface unit, the BFS host module requesting the second file system to perform a file processing procedure according to the BFS command, and transmitting a BFS result from the BFS host module to the BFS client module via the interface unit.

12. The mobile communication device of claim 11, wherein in response to the request, the BFS client module temporarily stores the BFS command and a target parameter corresponding to the BFS command into a register of the interface unit, and temporarily stores target data corresponding to the BFS command into a first-in-first-out (FIFO) queue of the interface unit.

13. The mobile communication device of claim 12, wherein after the BFS command is stored into the register, the interface unit transmits an interrupt request to the BFS host module; after receiving the interrupt request, the BFS host module reads the BFS command and the target parameter from the register, and reads the target data from the FIFO queue.

14. The mobile communication device of claim 11, wherein the BFS host module periodically inspects the interface unit to detect whether the BFS command is temporarily stored in the interface unit.

15. The mobile communication device of claim 11, wherein the BFS host module temporarily stores the BFS result and a result parameter corresponding to the BFS result into a register of the interface unit, and temporarily stores result data corresponding to the BFS result into a first-in-first-out (FIFO) queue of the interface unit.

16. The mobile communication device of claim 15, wherein after the BFS result is stored into the register, the interface unit transmits an interrupt request to the BFS client module; after receiving the interrupt request, the BFS client module reads the BFS result and the result parameter from the register, and reads the result data from the FIFO queue.

17. The mobile communication device of claim 11, wherein the BFS command represents the first file system requests the second file system to open a target file, and the BFS command comprises an open mode, a target file path, and a target file name of the target file, and the BFS result comprises a file pointer.

18. The mobile communication device of claim 11, wherein the BFS command represents the first file system requests the second file system to read a target file, the BFS command comprises a read unit size, a read unit number, and a file pointer, and the BFS result comprises read data, a successfully-read number, and a read result.

19. The mobile communication device of claim 11, wherein the BFS command represents the first file system requests the second file system to write data into a target file, the BFS command comprises a write unit size, a write unit number, and a file pointer, and the BFS result comprises a successfully-written number, and a write result.

20. The mobile communication device of claim 11, wherein the BFS command represents the first file system requests the second file system to search a target file, the BFS command comprises a file pointer, a shift amount, and a start point, and the BFS result comprises a search result.

21. The mobile communication device of claim 11, wherein the BFS command represents the first file system requests the second file system to close a target file, the BFS command comprises a file pointer, and the BFS result comprises a close result.

22. The mobile communication device of claim 11, further comprising:
a memory, if the BFS command represents the first file system requests the second file system to open a target file, in the file processing procedure, the second file system temporarily storing the target file in the memory,
and adding an entry corresponding to the target file in a file mapping table of the memory.

23. The mobile communication device of claim 22, wherein if the first file system then requests the second file system to open the target file, the second file system read the target file temporarily stored in the memory based on the file mapping table.

24. The mobile communication device of claim 22, wherein the baseband processor further comprises:
a first buffer memory, in the file processing procedure, the second file system temporarily storing parts of the target file into the first buffer memory.

25. The mobile communication device of claim 22, wherein the application processor further comprises:
a second buffer memory, the BFS client module temporarily storing the BFS result into the second buffer memory.
